(19) United States
(12) Patent Application Publication
(10) Pub. No.: US 2007/0189837 A1
(43) Pub. Date: Aug. 16, 2007

(54) TAN HAND

(76) Inventor: David W. Butler, Murrells Inlet, SC (US)

Correspondence Address: DAVID W. BUTLER, 105 INDIAN WELLS COURT, MURRELLS INLET, SC, 29576, US

(21) Appl. No.: 11/585,329

(22) Filed: Oct. 23, 2006

Related U.S. Application Data
(60) Provisional application No. 60/729,714, filed on Oct. 25, 2005.

(51) Int. Cl. B05C 17/005

(52) U.S. Cl. 401/196

(57) ABSTRACT

The TAN HAND is a product designed to make the application of suntan oil/lotion easy and cleaner. The TAN HAND's unique construction makes reaching all hard areas of the body a spray away. Just pump the TAN HAND's trigger to release your favorite suntan oil/lotion onto a soft spongy applicator. Then apply. When finished with your tanning session just rinse the TAN HAND's hand in water and slip on its glove for storage. Then you will ready for your next day in the sun. When you need a friend in the sand, the TAN HAND.

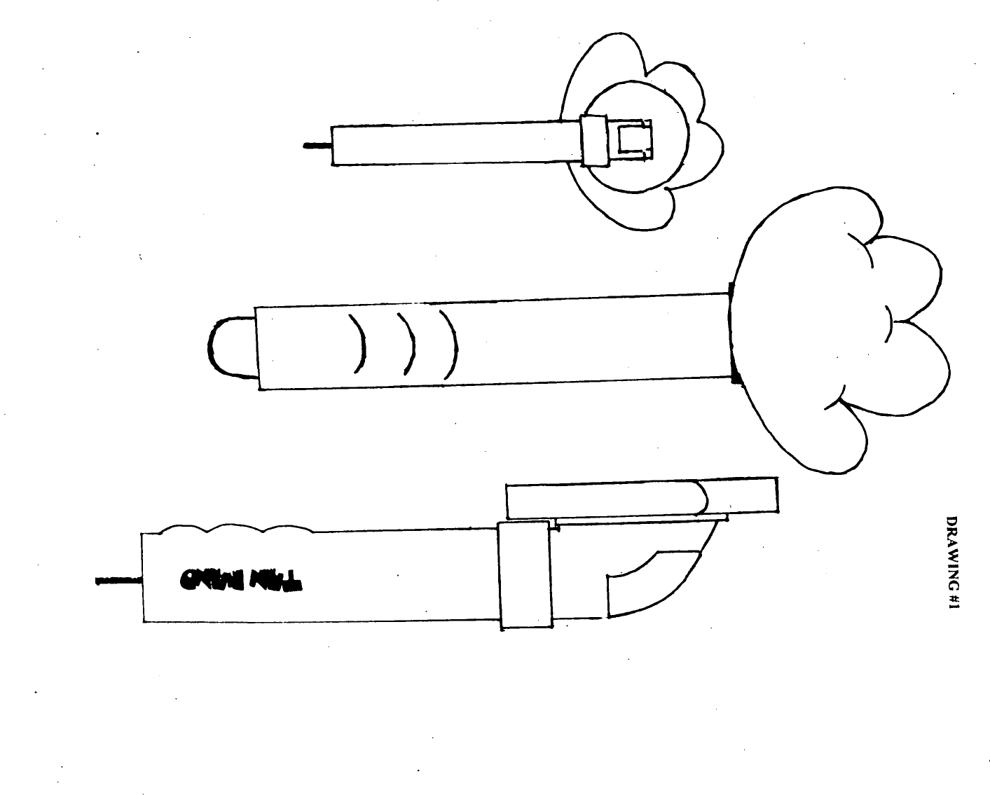

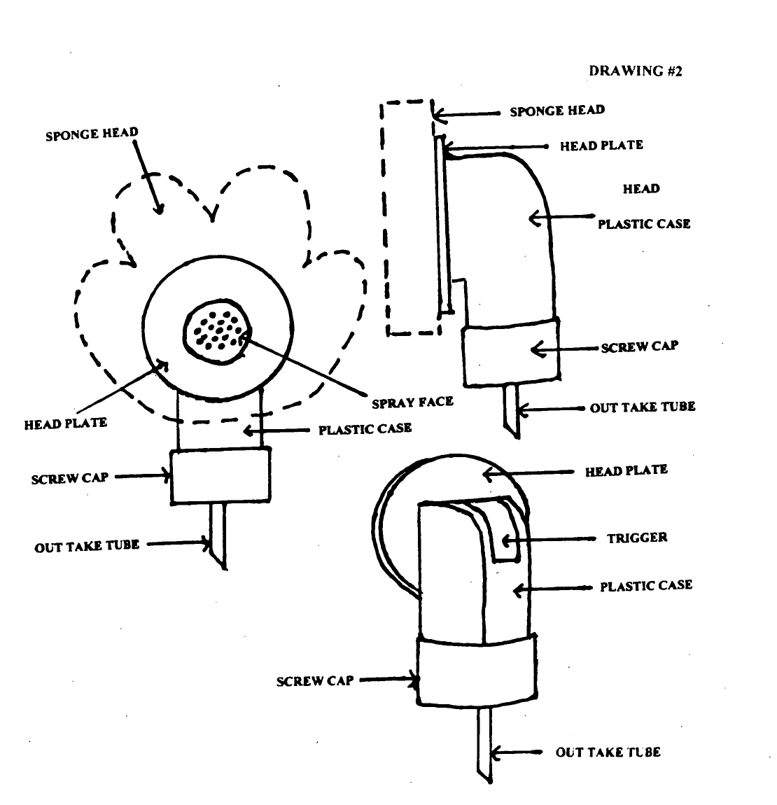

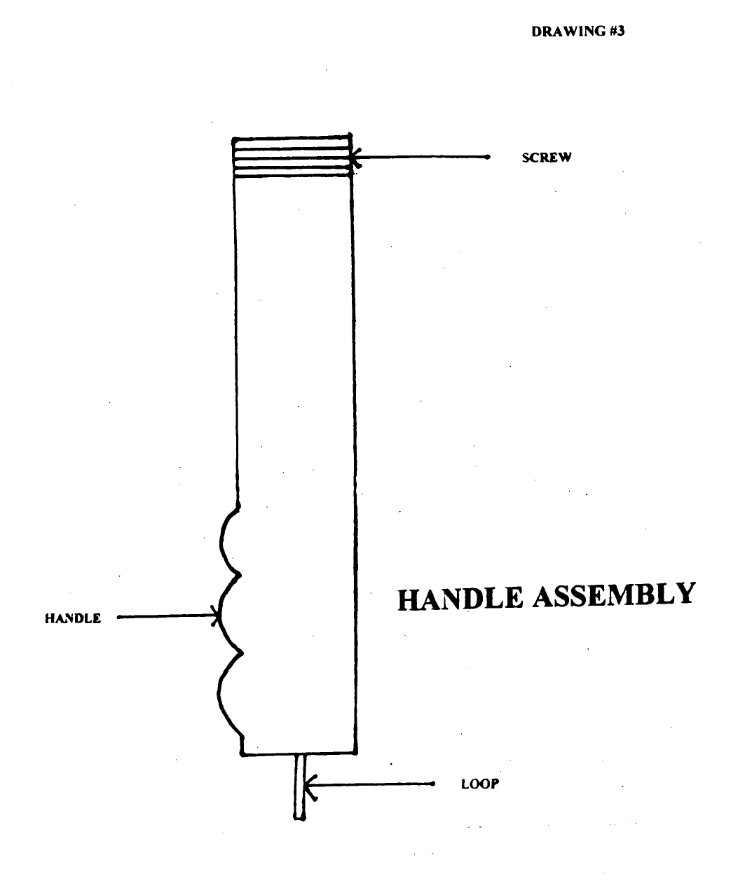

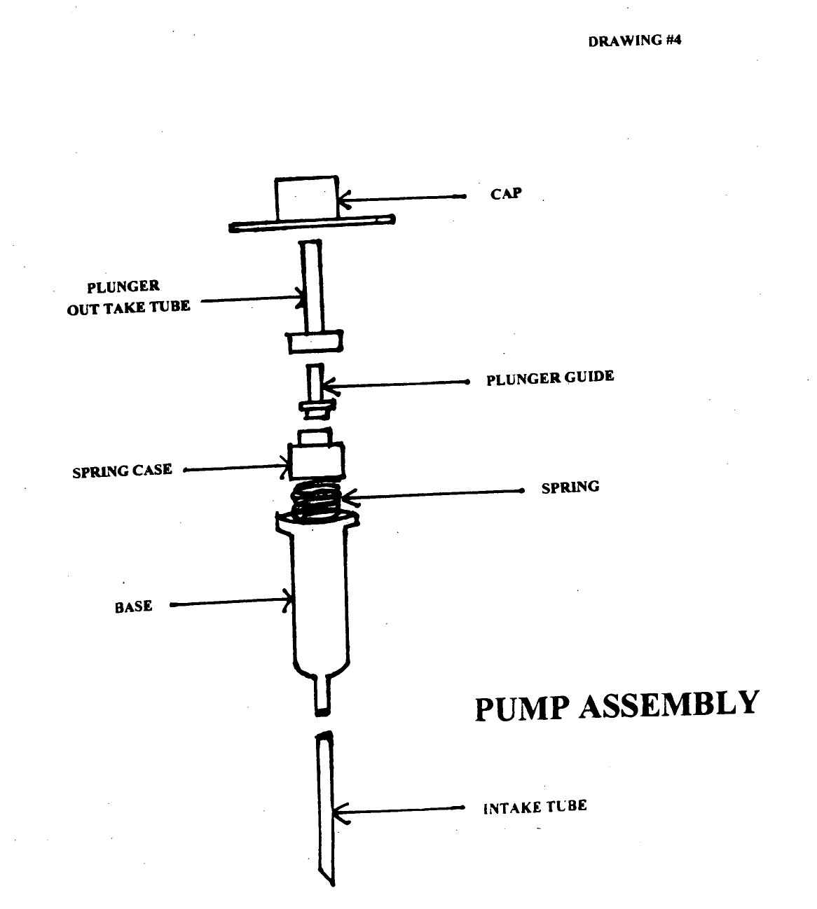

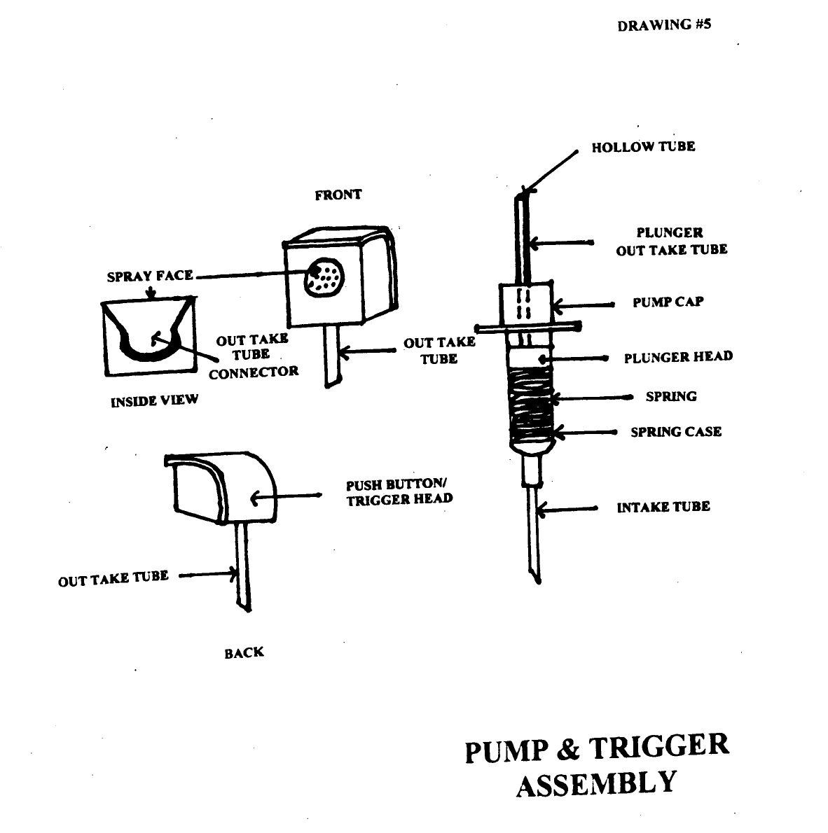

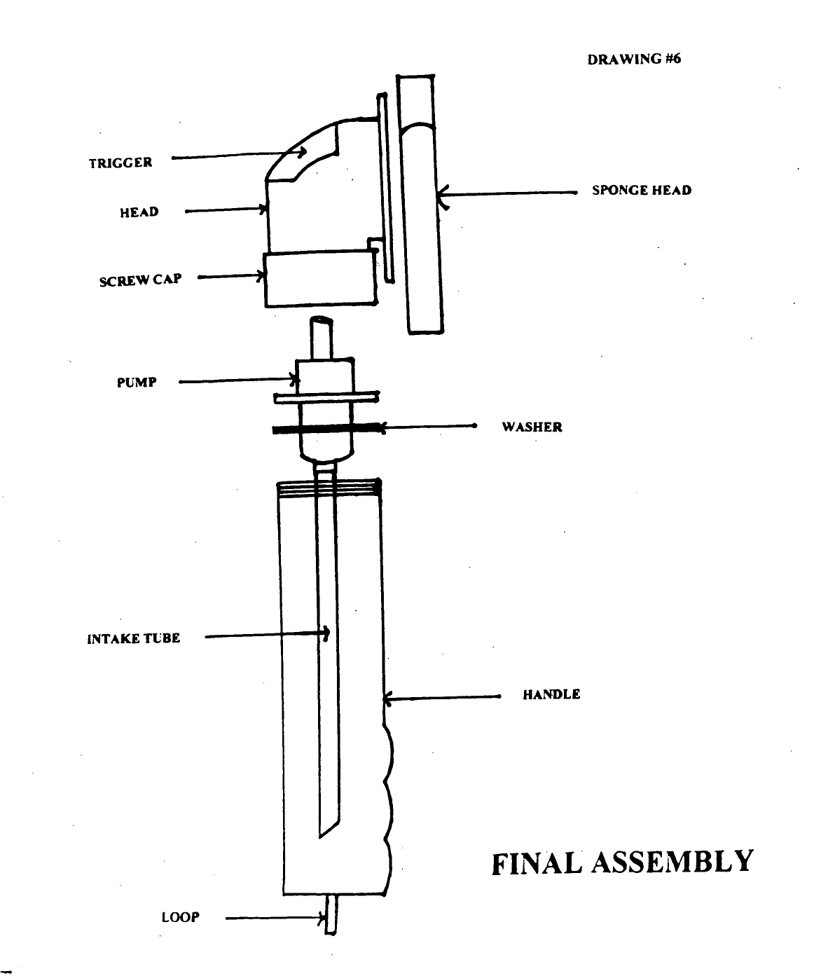

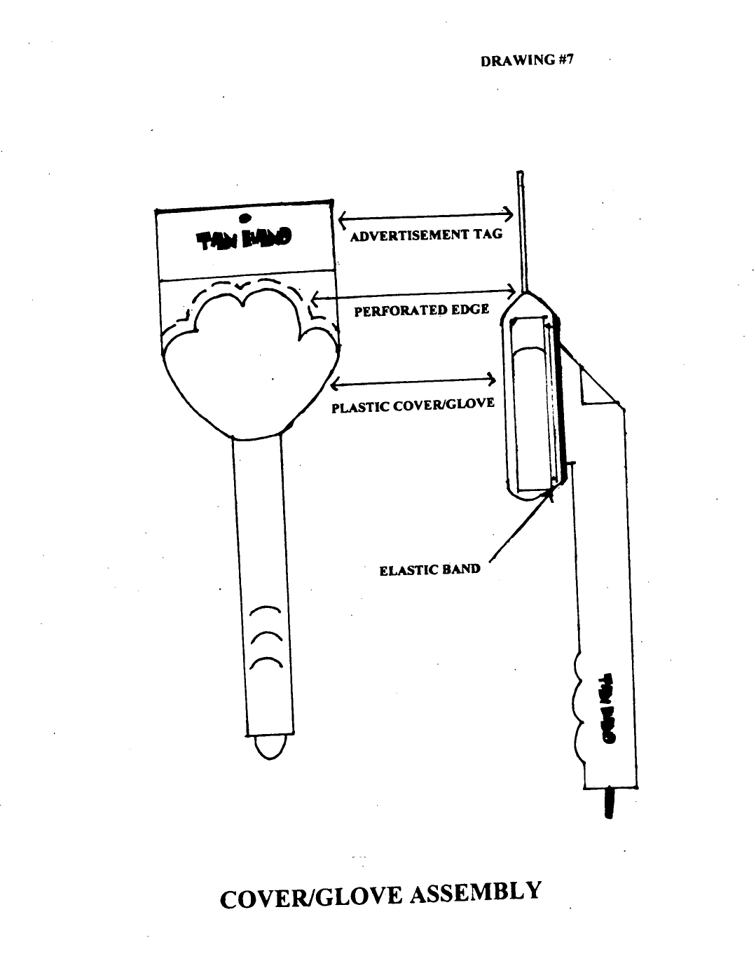

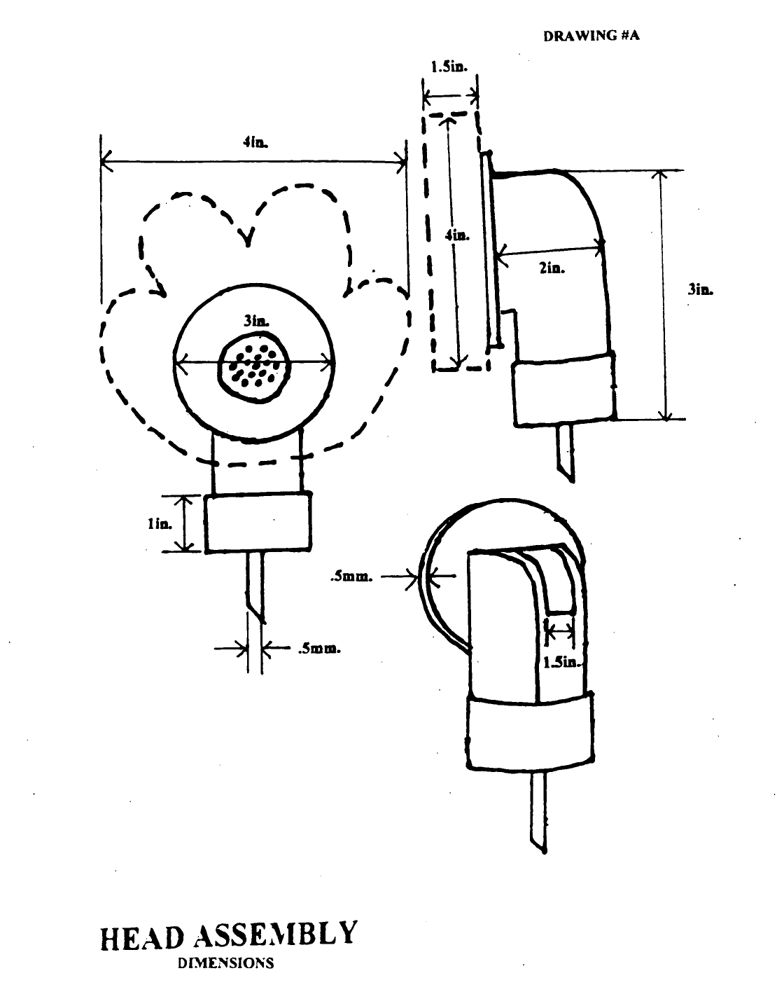

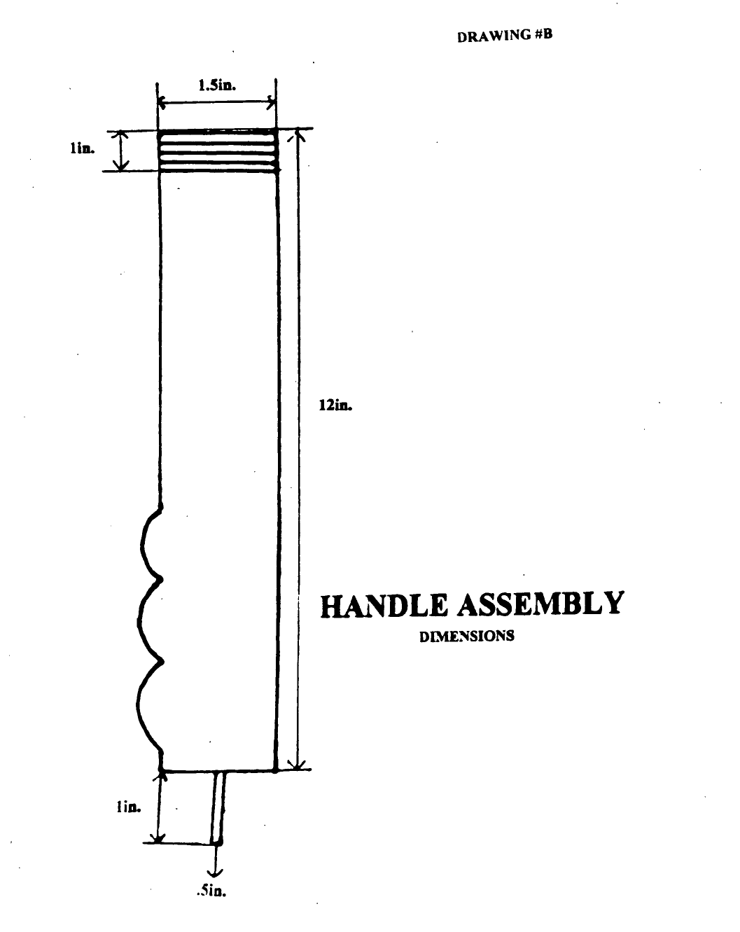

The main parts of the TAN HAND, the Handle and Head, will be made of plastic. Plastic injection die cast molds will be made to dimensions (see DRAWING A# & B#). The Pump assembly (see DRAWING 4#) is not claimed as a part of this patent. They are pre-built from a separate manufacturer. The Face or Hand of the applicator will be cut to specification (see DRAWING 2#) from a sponge sheet.

The Handle will have an inward screw cut into its top and a loop on the bottom (see DRAWING 3# & 6#). The Head will have an outward screw cap to accept the Handle and to insure a tight fit. The pre-built Pump assembly will be fitted into Head assembly (see DRAWING 6#). When completed the sponge Face will be attached with water tight adhesive. The TAN HAND now can be filled with sun tan oil or lotion, just pump the Trigger for a quick, easy and clean application. The TAN HAND will come with a plastic cover/glove for storage, which will be incorporated in its packaging (see DRAWING 7#).

### DESCRIPTION OF INVENTION

The TAN HAND is a device designed to dispense sun tan oil and lotion. Its design and application face makes hard to reach areas of the body accessible for a more even sun tan.

The TAN HAND has four parts to its assembly. The Handle, Head, Face and Pump assembly (Please refer to Description of Drawing).

Dimensions:

Head: (Drawing #2)
Length 3 in.
Circumference 1.5 in.
Face 3.5 in.
Trigger 1×3 in. (Drawing #5)

Handle: (Drawing #3)
Length 12 in.
Circumference 1.5 in.

Face: (Drawing #2)
Sponge cut to a 4×4 in. and 0.5 in. wide Hand.

Pump: (Drawing #4)
Pre-built pump assembly.

I claim:

1.) A sun tan oil/lotion dispenser comprising: the long plastic handle will house the sun tan oil/lotion. The head assembly will hold the trigger, pump and the sponge applicator hand. By pumping the trigger, sun tan oil/lotion will be released onto the sponge application hand. The long plastic handle and the sponge application hand will make applying sun tan oil/lotion to all of the hard to reach areas of the body for a more even tan.

2.) A pump assembly, which is not claimed as a part of this invention. But is used in its construction and function.
